(19) United States
(12) Patent Application Publication
(10) Pub. No.: US 2026/0042950 A1
(43) Pub. Date: Feb. 12, 2026

(54) THERMITE COMPOSITION FOR A PROCESS OF PLUGGING AND ABANDONING A PETROLEUM WELL AND PROCESS OF PLUGGING AND ABANDONING A PETROLEUM WELL USING SAID THERMITE COMPOSITION

(71) Applicant: PTT EXPLORATION AND PRODUCTION PUBLIC COMPANY LIMITED, Bangkok (TH)

(72) Inventors: Wararit TOEMPROMARAJ, Bangkok (TH); Kittithuch HNURUANG, Bangkok (TH); Passaworn SILAKORN, Bangkok (TH); Chatawut CHANVANICHSKUL, Bangkok (TH); Kannikar TANGPATOMWONG, Bangkok (TH); Nutt ROONGRUANG, Bangkok (TH); Pramote PHLOI-MONTRI, Bangkok (TH); Suwin SOMPOPSART, Bangkok (TH); Chatchai KONGDACHUDOMKUL, Bangkok (TH); Tachai LUANGVARANUNT, Bangkok (TH); Sirichai LEELACHAO, Bangkok (TH); Patnoptanut RATTANAPIEN, Bangkok (TH); Suvanchai PONGSUGITWAT, Bangkok (TH); Patama VISUTTIPITUKUL, Bangkok (TH); Gobboon LOTHONGKUM, Bangkok (TH); Thanawat MEESAK, Bangkok (TH); Ratchatee TECHAPIESANCHAROENKIJ, Bangkok (TH)

(21) Appl. No.: 19/100,832

(22) PCT Filed: Aug. 4, 2023
(86) PCT No.: PCT/IB2023/057890

§ 371 Date: Feb. 3, 2025

(30) Foreign Application Priority Data
Aug. 4, 2022 (TH) 2201004913

(51) Int. Cl. C09K 8/42; C06B 33/00; C09K 8/467; E21B 29/00; E21B 33/13; E21B 36/00

(52) U.S. Cl. CPC C09K 8/426; C06B 33/00; C09K 8/467; E21B 33/13; E21B 36/00; E21B 29/00

(57) ABSTRACT

A thermite composition for a process of plugging and abandoning a petroleum well comprises a tube-scaling composition and a gas leakage-preventing composition. The tube-scaling composition comprises aluminium and a metal oxide, and the gas leakage-preventing composition comprises a metal or an alloy with a melting point ranging from 100-300° C. The tube-scaling composition is arranged at the bottom, followed by the gas leakage-preventing composition. The thermite composition further comprises a tube-opening composition comprising aluminium and a metal oxide. The process of plugging and abandoning a petroleum well using the thermite composition involves introducing the thermite composition which is arranged in layers in the petroleum well to be plugged and abandoned, and initiating an ignition to trigger a thermite reaction, which melts the metal for tube sealing and prevents gas leakage.

### TECHNICAL FIELD

Chemistry and petrochemistry related to a thermite composition for a process of plugging and abandoning a petroleum well and a process of plugging and abandoning a petroleum well using said thermite composition.

### BACKGROUND OF THE INVENTION

Plugging and abandoning a petroleum well is a process for removing installations in the petroleum business in a case where said petroleum well is commercially inefficient or a concession granted by a government has expired. The process must be carried out cautiously in order to avoid creating an impact on the surrounding environment. The process consists of permanently closing and abandoning the well, removing the petroleum production platform and removing the petroleum tubing under the sea. In general, permanently closing and abandoning a well is performed by injecting cement into a casing, which extends deep into the rock layers that contain petroleum, to permanently close the well. Upon cement solidification, a test must be carried out to ensure that there is no petroleum leakage. Then, the petroleum production platform above the sea level or the structure on the top side can be removed, followed respectively by the structure under the sea level or the jacket. The petroleum tubing under the sea is removed after cleaning the tubing of residual contaminants to prevent the contaminants from leaking into the sea.

Another developed method with efficiency in plugging and abandoning a petroleum well is to block the remaining petroleum in a wellbore with a metal, such as bismuth, by melting the metal and allowing it to solidify and expand in order to block the petroleum production well. Extremely high thermal energy is required to melt the metal. A thermite composition which is a composition of reducing metal (aluminium) and metal oxide is thus used to activate a thermite reaction, which provides sufficiently high heat and energy to cause the metal to melt and expand to block a petroleum well. The energy generated can also be used to cut the petroleum tubing in the well to be removed.

The thermite reaction is a reduction reaction of a metal compound, especially the reduction of metal oxide using aluminium (Al) and magnesium (Mg), which are reducing metals commonly used due to their low melting point and high exothermic rate. An example of a reaction with the use of aluminium as a reducing metal is a reaction having a chemical equation: metal oxide+aluminium powder which form aluminium oxide+metal+heat. The heat generated is high up to 2,000° C. and causes the metal to be in a liquid state. The plugging and abandonment of the petroleum well using the thermite reaction is a part of the procedure has been disclosed in some of the prior arts such as the examples of invention according to the following patents.

WO 2020169977 A1, titled THERMITE METHOD OF ABANDONING A WELL, discloses a method of abandoning a petroleum well using a thermite composition by filling the innermost of the petroleum tubing to be removed with the thermite composition in order to cut the tubing from the inside, then igniting the thermite composition to initiate a reaction at the bottom of the tubing.

WO 2021038254 A1, titled METHOD OF ABANDONING A WELL, discloses a method of plugging a wellbore with a thermite composition. The invention uses a plurality of cartridges for containing the thermite composition and delivering it to the wellbore to be plugged and sealed. When reaching a desired position, the first cartridge is ignited to enable the subsequent cartridge to operate.

The thermite composition used in the process of plugging and abandoning petroleum well can be selected from a variety of chemicals as in the examples of invention according to the following patents.

US20190055806 A1, titled HEAT SOURCES AND ALLOYS FOR USE IN DOWN-HOLE APPLICATIONS, discloses the use of heat obtained from a thermite reaction to generate an elevated temperature inside the well, which melts an alloy of bismuth and germanium and allows it to be used in the plugging and abandonment. A damping agent is also used in the composition.

WO 2022038387 A1, titled BISMUTH AND CEMENT METHOD OF ABANDONING A WELL AND MEANS OF REAL TIME VERIFICATION OF THE BISMUTH AND CEMENT PLACEMENT PROCESS, discloses a method of plugging and abandoning a petroleum well using bismuth and cement. A perforated tube is used to contain bismuth and deliver it to the well. Upon heating bismuth with the thermite reaction, bismuth melts and flows out through the drilled holes to an unheated part. The bismuth then solidifies and seals the tube.

However, a problem found in the use of thermite reaction is excessive combustion which leads to an explosion from an exothermic reaction, which could damage equipment or cause injury to operators. In some cases, inappropriate use of chemical composition for the thermite reaction may cause leakage or loose sealing in the plugging of petroleum well due to insufficient metal for closing the tube to be removed, resulting in the leakage of natural gas which adversely affects the environment. Moreover, the reaction that occurs is not capable of effectively cutting the tube to be removed; consequently, the tube is not sufficiently sealed to prevent leakage, which may result in the escape of natural gas.

Therefore, the present invention develops a thermite composition with an addition of a metal in order to delay the reaction so that it is not too harmful, increase the metal for tube sealing, develop a ratio of a reducing metal and metal oxide that is highly efficient in destroying the petroleum tubing to be removed, and seal the tube using a suitable thermite reaction. Also, a study was conducted with an aim to increase the thermite reaction efficiency to cause explosion to destroy and seal the tube in a highly efficient manner by inventing a layering of the thermite composition so that each layer serves to destroy, plug, and seal the petroleum wellbore, respectively. The aforementioned developments have yet to be discovered.

### SUMMARY OF THE INVENTION

A thermite composition for a process of plugging and abandoning a petroleum well comprises a tube-sealing composition and a gas leakage-preventing composition, wherein the tube-sealing composition comprises aluminium and a metal oxide, and the gas leakage-preventing composition comprises a metal or an alloy with a melting point ranging from 100-300° C. The tube-sealing composition is arranged at the bottom, followed by the gas leakage-preventing composition. The thermite composition further comprises a tube-opening composition comprising aluminium and a metal oxide.

A process of plugging and abandoning a petroleum well using the thermite composition according to the present invention comprises plugging a petroleum well to be plugged and abandoned with a mechanical bridge plug, and introducing the thermite composition which is arranged in layers in the petroleum well to be plugged and abandoned, and initiating an ignition to trigger a thermite reaction, which melts the metal for tube sealing and prevents gas leakage.

The present invention is aimed at producing a thermite composition with high efficiency in plugging and abandoning a petroleum well, as well as developing a process which uses said thermite composition in the plugging and abandonment of a petroleum well to reduce environmental pollution potentially caused by the leakage of natural gas from unused wellbore or petroleum tubing.

### DETAILED DESCRIPTION

The present invention relates to a thermite composition for the process of plugging and abandoning a petroleum well and a process of plugging and abandoning a petroleum well using said thermite composition to trigger the thermite reaction, which will be described hereinafter in various aspects of the invention.

Any aspects shown herein shall encompass application to other aspects of the present invention, unless stated otherwise.

Technical or scientific terms used herein have the meanings as understood by those skilled in the art, unless stated otherwise.

Any tools, equipment, methods, or chemicals mentioned herein shall refer to tools, equipment, methods, or chemicals commonly practiced or used by those skilled in the art, unless expressly stated to be special or specific tools, equipment, methods, or chemicals for the present invention.

The following illustrates the detailed description without an intention to limit the scope of the invention.

The present invention relates to the thermite composition for the process of plugging and abandoning a petroleum well and the process of plugging and abandoning a petroleum well using said thermite composition. The thermite composition for the process of plugging and abandoning a petroleum well comprises:
a) a tube-sealing composition comprising:
   aluminium in an amount of 10-40 wt %, and
   a metal oxide in an amount of 60-90 wt %, and
b) a gas leakage-preventing composition comprising a metal with a melting point ranging from 100-300° C. A weight ratio of the component b) to a) is in a range of 1:5 to 1:1.

In one embodiment, the metal oxide is selected from any one of copper oxide, molybdenum oxide, silicon dioxide, cobalt oxide, chromium oxide, titanium dioxide, nickel oxide, ferric oxide, ferrous oxide, or a mixture thereof.

In one embodiment, the metal with a melting point ranging from 100-300° C. is selected from bismuth, tin, or an alloy thereof.

In another embodiment, the tube-sealing composition further comprises a metal powder in an amount of 1-35 wt % of the tube-sealing composition.

In one embodiment, the metal powder is selected from any one of iron powder, chromium powder, nickel powder, molybdenum powder, or a mixture thereof.

In another embodiment, the tube-sealing composition further comprises an auxiliary agent for separating metal slag in an amount of 1-35 wt % of the tube-sealing composition.

In another embodiment, the tube-sealing composition further comprises the auxiliary agent for separating metal slag in an amount of 5-15 wt % of the tube-sealing composition.

In a preferred embodiment, the auxiliary agent for separating metal slag is an oxide compound of an element selected from any one of calcium, magnesium, silicon, phosphorus, or a mixture thereof.

In a preferred embodiment, the auxiliary agent for separating metal slag is any one of an alloy of iron and calcium or calcium silicide compound or a mixture thereof.

In one embodiment, the thermite composition for a process of plugging and abandoning a petroleum well further comprises a tube-opening composition comprising:
aluminium in an amount of 10-40 wt %, and
a metal oxide in an amount of 60-90 wt %.

In a preferred embodiment, the thermite composition further comprises the tube-opening composition comprising:
aluminium in an amount of 15-30 wt %, and
a metal oxide in an amount of 70-85 wt %.

In a preferred embodiment, the metal oxide for the tube-opening composition is selected from any one of molybdenum oxide, nickel oxide, chromium oxide, ferric oxide, ferrous oxide, or a mixture thereof.

In a preferred embodiment, the tube-opening composition comprises:
aluminium in an amount of 15-25 wt %,
a molybdenum oxide in an amount of 15-35 wt %, and
a nickel oxide in an amount of 45-65 wt %.

In a preferred embodiment, the tube-opening composition comprises:
aluminium in an amount of 10-30 wt %,
a nickel oxide in an amount of 55-75 wt %, and
an iron oxide in a ratio of 5-25 wt %.

In a preferred embodiment, the tube-opening composition comprises:
aluminium in an amount of 15-35 wt %,
a molybdenum oxide in an amount of 35-55 wt %, and
a chromium oxide in an amount of 20-40 wt %.

In a preferred embodiment, the tube-opening composition comprises:
aluminium in an amount of 15-35 wt %,
a molybdenum oxide in an amount of 40-60 wt %, and
a chromium oxide in an amount of 15-35 wt %.

In an application of the thermite composition, the thermite composition is layered inside a closed, hollow tubing. The tube-sealing composition is layered at the bottom, followed by the gas leakage-preventing composition.

In one embodiment, the layering of the thermite composition further comprises a layering of the tube-opening composition underneath the tube-sealing composition.

In one embodiment, the layering of each thermite composition layer depends on a tubing diameter.

In a preferred embodiment, each thermite composition layer has a thickness ranging from 1-60 m.

A process of plugging and abandoning a petroleum well using said thermite composition comprises the following steps:
a) preparing the thermite composition, which comprises
   1.1 the tube-sealing composition comprising:
      aluminium in an amount of 10-40 wt %, and
      the metal oxide in an amount of 60-90 wt %

In one embodiment, the metal oxide is selected from any one of copper oxide, molybdenum oxide, silicon dioxide, cobalt oxide, chromium oxide, titanium dioxide, nickel oxide, ferric oxide, ferrous oxide, or a mixture thereof.
1.2 the gas leakage-preventing composition comprising a metal with a melting point ranging from 100-300° C.,

In one embodiment, the metal with a melting point ranging from 100-300° C. is selected from bismuth, tin, or an alloy thereof.
each component 1.1 and 1.2 being mixed separately before arranging in a tubing;
b) plugging a petroleum well to be plugged and abandoned with a mechanical bridge plug before introducing the thermite composition into it;
c) layering the thermite composition prepared in step a) in a closed, hollow tubing, wherein the layering of the thermite composition provides the tube-sealing composition at the bottom, followed by the gas leakage-preventing composition, before introducing to the petroleum well to be plugged and abandoned;
d) initiating an ignition to generate thermal energy, triggering a thermite reaction that causes metal melting for tube sealing and preventing gas leakage, wherein an explosion caused by said thermite reaction occurs on the lateral and lower sides.

In one embodiment, the tube-sealing composition in step a) of preparing the thermite composition further comprises a metal powder in an amount of 1-35 wt % of the tube-sealing composition.

In another embodiment, the metal powder is selected from any one of iron powder, chromium powder, nickel powder, molybdenum powder, or a mixture thereof.

In one embodiment, the tube-sealing composition in step a) of preparing the thermite composition further comprises an auxiliary agent for separating metal slag in an amount of 1-35 wt % of the tube-sealing composition.

In another embodiment, the tube-sealing composition in step a) of preparing the thermite composition further comprises the auxiliary agent for separating metal slag in an amount of 5-15 wt % of the tube-sealing composition.

In one embodiment, the auxiliary agent for separating metal slag is an oxide compound of an element selected from any one of calcium, magnesium, silicon, phosphorus, or a mixture thereof.

In a preferred embodiment, the auxiliary agent for separating metal slag is preferably any one of an alloy of iron and calcium or calcium, silicide compound, or a mixture thereof.

In one embodiment, in step c) of layering the thermite composition, the layering of each thermite composition layer depends on a tubing diameter.

In a preferred embodiment, in step c) of arranging the thermite composition, each thermite composition layer has a thickness ranging from 1-60 m.

In another embodiment, step c) of layering the thermite composition further comprises tightly sealing a tubing or covering a tubing with a thermal insulation material.

In one embodiment, step d) of initiating the ignition is performed by heating between 500-1,500° C. to trigger the thermite reaction.

The process of plugging and abandoning a petroleum well using the thermite composition further comprises a step of opening a tubing prior to melting the metal for tube sealing and preventing gas leakage. The opening of a tubing is selected from any one of cutting a tubing open using a mechanical force, perforation, or opening a tubing using a chemical composition, or a combination thereof.

Opening a tubing using a mechanical force can be performed by, for example, cutting with a blade or other spreader cutters that are capable of cutting a tubing.

In one embodiment, the chemical composition, which acts as a tube-opening composition in the step of opening a tubing comprises:
aluminium in an amount of 10-40 wt %, and
a metal oxide in an amount of 60-90 wt %.

In one embodiment, the metal oxide is selected from any one of molybdenum oxide, nickel oxide, chromium oxide, ferric oxide, ferrous oxide, calcium peroxide, calcium oxide, or a mixture thereof.

In a preferred embodiment, the tube-opening composition preferably comprises:
aluminium in an amount of 15-25 wt %,
a molybdenum oxide in an amount of 15-35 wt %, and
a nickel oxide in an amount of 45-65 wt %.

In a preferred embodiment, the tube-opening composition preferably comprises:
aluminium in an amount of 10-30 wt %,
a nickel oxide in an amount of 55-75 wt %, and
an iron oxide in an amount of 5-25 wt %.

In a preferred embodiment, the tube-opening composition preferably comprises:
aluminium in an amount of 15-35 wt %,
a molybdenum oxide in an amount of 35-55 wt %, and
a chromium oxide in an amount of 20-40 wt %.

In a preferred embodiment, the tube-opening composition preferably comprises:
aluminium in an amount of 15-35 wt %,
a molybdenum oxide in an amount of 40-60 wt %, and
an iron oxide in an amount of 15-35 wt %.

In one embodiment, step c) of layering the thermite composition comprises a layering of the tube-opening composition underneath the tube-sealing composition.

The following examples merely illustrate an aspect of the present invention to help clarify the invention and are not intended to limit the scope of the invention in any way. The scope of the invention shall be in compliance with the appended claims.

Example 1: The thermite composition according to the present invention comprises:
1. The tube-opening composition comprising:
   Composition 1
      aluminium in an amount of 15-25 wt %
      molybdenum oxide in an amount of 15-35 wt %
      nickel oxide in an amount of 45-65 wt %
   Composition 2
      aluminium in an amount of 10-30 wt %
      nickel oxide in an amount of 55-75 wt %
      iron oxide in an amount of 5-25 wt %
   Composition 3
      aluminium in an amount of 15-35 wt %
      molybdenum oxide in an amount of 35-55 wt %
      chromium oxide in an amount of 20-40 wt %
   Composition 4
aluminium in an amount of 15-35 wt %
molybdenum oxide in an amount of 40-60 wt %
iron oxide in an amount of 15-35 wt %.
2. The tube-sealing composition comprises:
   aluminium in an amount of 10-40 wt %
metal oxide in an amount of 60-90 wt %.
3. The gas leakage-preventing composition comprises the metal with a melting point ranging from 100-300° C. which is selected from bismuth, tin, or an alloy thereof.

Example 2: The test results of the thermite composition in terms of the metal oxide for

the process of plugging and abandoning a petroleum well

For the tube-sealing composition and the tube-opening composition comprising aluminium and metal oxide, a test was conducted to determine a suitable ratio of metal oxide that is effective in opening and sealing the tubing. The details of the metal oxide tested and its efficiency in opening a tubing are as follows.

TABLE 1
The metal oxide of the thermite composition
for opening and sealing a tubing is shown.

| | Copper | Chromium | Molybdenum | Cobalt | Nickel | Ferric |
|---|---|---|---|---|---|---|
| | oxide | oxide | oxide | oxide | oxide | oxide |
| Compound | (CuO) | (Cr₂O₃) | (MoO₃) | (CoO) | (NiO) | (Fe₂O₃) |
| Example 1 of metal | | 40 | 60 | | | |
| oxide | | | | | | |
| Example 2 of metal | | 30 | 70 | | | |
| oxide | | | | | | |
| Example 3 of metal | | 30 | | 70 | | |
| oxide | | | | | | |
| Example 4 of metal | | 20 | | 80 | | |
| oxide | | | | | | |
| Example 5 of metal | 60 | 40 | | | | |
| oxide | | | | | | |
| Example 6 of metal | | 25 | | | | 75 |
| oxide | | | | | | |
| Example 7 of metal | | 27.5 | | | | 72.5 |
| oxide | | | | | | |
| Example 8 of metal | | | 30 | | 70 | |
| oxide | | | | | | |
| Example 9 of metal | | | | | 80 | 20 |
| oxide | | | | | | |
| Example 10 of metal | | | 70 | | | 30 |
| oxide | | | | | | |

* Note:
The metal content is in wt %.

It was found that when using Examples 1-4 of metal oxide, the tubing could be cut and opened with less damage (cut pipe, less damage). Example 5 cut and opened the tubing with larger damage to the tubing than Examples 1-4 (cut pipe, large damage). Examples 6-7 could open the tubing with large damage which could create a big hole (large damage, big hole). Examples 8-10 of metal oxide could cut and open the tubing with damage which could create a big hole and allowed the slag to flow smoothly out of the tubing (cut pipe, large damage, big hole, slag flow).

Example 3: The process of plugging and abandoning the petroleum well in a case where the petroleum or gas tubing is a single-layer tubing.

The process of plugging and abandoning a petroleum well in a case where the petroleum or gas tubing is the single-layer tubing comprises the following steps.
a) preparing the thermite composition comprising:
   1.1. the tube-sealing composition comprising:
      aluminium in an amount of 10-40 wt %,
      metal oxide in an amount of 60-90 wt %,
      additionally, metal powder in an amount of 1-35 wt % and auxiliary agent for separating metal slag in an amount of 1-35 wt %
   1.2. the gas leakage-preventing composition comprising the metal with a melting point ranging from 100-300° C.
   Each component 1.1 and 1.2 is mixed separately before arranging in the tubing. The weight ratio of the gas leakage-preventing composition to the tube-sealing composition is in a range of 1:5 to 1:1.
b) plugging a petroleum well to be plugged and abandoned with a mechanical bridge plug before introducing the thermite composition into it;
c) layering the thermite composition prepared in step a) in a closed, hollow tubing, wherein the layering of the thermite composition provides the tube-sealing composition at the bottom, followed by the gas leakage-preventing composition, before introducing to the petroleum well to be plugged and abandoned; the layering of each thermite composition layer depends on the tubing diameter, each thermite composition layer has a thickness ranging from 1-60 m;
d) initiating an ignition to generate thermal energy, triggering a thermite reaction by heating between 500-1,500° C. to cause metal melting for tube sealing and preventing gas leakage, wherein an explosion caused by said thermite reaction occurs on the lateral and lower sides.

Example 4: The process of plugging and abandoning the petroleum well in a case where the petroleum or gas tubing is a double-layer tubing comprises the following steps:
a) preparing the thermite composition, which comprises:
   1.1. the tube-opening composition comprising:
      aluminium in an amount of 10-40 wt %
      metal oxide in an amount of 60-90 wt %
   1.2. the tube-sealing composition comprising:
      aluminium in an amount of 10-40 wt %
      metal oxide in an amount of 60-90 wt %
      additionally, metal powder in an amount of 1-35 wt % and auxiliary agent for separating metal slag in an amount of 1-35 wt %
   1.3. the gas leakage-preventing composition comprising the metal with a melting point ranging from 100-300° C.

Each component 1.1, 1.2, and 1.3 is mixed separately before arranging in the tubing. The weight ratio of the gas leakage-preventing composition to the tube-sealing composition is in a range of 1:5 to 1:1.
b) plugging a petroleum well to be plugged and abandoned with a mechanical bridge plug before introducing the thermite composition into it;
c) Layering the thermite composition prepared in step a) in a closed, hollow tubing. The layering of the thermite composition provides the tube-opening composition at the bottom, followed by the tube-sealing composition and the gas leakage-preventing composition at the topmost, before introducing to the petroleum well to be plugged and abandoned. The layering of each thermite composition layer depends on the tubing diameter, each thermite composition layer has a thickness ranging from 1-60 m.
d) initiating an ignition to generate thermal energy, triggering the thermite reaction by heating between 500-1,500° C. to cause the melting of the metal for tube sealing and preventing gas leakage. An explosion caused by said thermite reaction is an explosion on the lateral and lower sides.

Any modification or change may be clearly understood and can be carried out by those skilled in the art under the scope and spirit of the present invention as shown in the appended claims.

### BEST MODE OF THE INVENTION

Best mode of the invention is as described in the detailed description of the invention.

What is claimed is:

1. A thermite composition for a process of plugging and abandoning a petroleum well, comprising:
a) a tube-sealing composition comprising
aluminium in an amount of 10-40 wt %, and
a metal oxide in an amount of 60-90 wt %
b) a gas leakage-preventing composition comprising a metal with a melting point ranging from 100-300° C.

2. The thermite composition for a process of plugging and abandoning a petroleum well according to claim 1, having a weight ratio of the component b) to a) ranging from 1:5 to 1:1.

3. The thermite composition for a process of plugging and abandoning a petroleum well according to claim 1 further comprising a tube-opening composition, which comprises:
aluminium in an amount of 10-40 wt %, and
a metal oxide in an amount of 60-90 wt %.

4. The thermite composition for a process of plugging and abandoning a petroleum well according to claim 1 further comprising a tube-opening composition, which comprises:
aluminium in an amount of 15-30 wt %, and
a metal oxide in an amount of 70-85 wt %.

5. The thermite composition for a process of plugging and abandoning a petroleum well according to claim 1, wherein the metal oxide is selected from any one of copper oxide, molybdenum oxide, silicon dioxide, cobalt oxide, chromium oxide, titanium dioxide, nickel oxide, ferric oxide, ferrous oxide, or a mixture thereof.

6. The thermite composition for a process of plugging and abandoning a petroleum well according to claim 1, wherein the metal with a melting point ranging from 100-300° C. is selected from bismuth, tin, or an alloy thereof.

7. The thermite composition for a process of plugging and abandoning a petroleum well according to claim 1, wherein the tube-sealing composition further comprises a metal powder in an amount of 1-35 wt % of the tube-sealing composition.

8. The thermite composition for a process of plugging and abandoning a petroleum well according to claim 7, wherein the metal powder is selected from any one of iron powder, chromium powder, nickel powder, molybdenum powder, or a mixture thereof.

9. The thermite composition for a process of plugging and abandoning a petroleum well according to claim 1, wherein the tube-sealing composition further comprises an auxiliary agent for separating metal slag in an amount of 1-35 wt % of the tube-sealing composition.

10. The thermite composition for a process of plugging and abandoning a petroleum well according to claim 1, wherein the tube-sealing composition further comprises an auxiliary agent for separating metal slag in an amount of 5-15 wt % of the tube-sealing composition.

11. The thermite composition for a process of plugging and abandoning a petroleum well according to claim 9 or 10, wherein the auxiliary agent for separating metal slag is preferably an oxide compound of an element selected from any one of calcium, magnesium, silicon, phosphorus, or a mixture thereof.

12. The thermite composition for a process of plugging and abandoning a petroleum well according to claim 9 or 10, wherein the auxiliary agent for separating metal slag is preferably any one of an alloy of iron and calcium, calcium silicide compound, or a mixture thereof.

13. The thermite composition for a process of plugging and abandoning a petroleum well according to claim 3 or 4, wherein the metal oxide is preferably selected from any one of molybdenum oxide, nickel oxide, chromium oxide ferric oxide, ferrous oxide, calcium peroxide, calcium oxide, or a mixture thereof.

14. The thermite composition for a process of plugging and abandoning a petroleum well according to claim 3 or 4, wherein the tube-opening composition preferably comprises:
aluminium in an amount of 15-25 wt %,
a molybdenum oxide in an amount of 15-35 wt %, and
a nickel oxide in an amount of 45-65 wt %.

15. The thermite composition for a process of plugging and abandoning a petroleum well according to claim 3 or 4, wherein the tube-opening composition preferably comprises:
aluminium in an amount of 10-30 wt %,
a nickel oxide in an amount of 55-75 wt %, and
an iron oxide in an amount of 5-25 wt %.

16. The thermite composition for a process of plugging and abandoning a petroleum well according to claim 3 or 4, wherein the tube-opening composition preferably comprises:
aluminium in an amount of 15-35 wt %,
a molybdenum oxide in an amount of 35-55 wt %, and
a chromium oxide in an amount of 20-40 wt %.

17. The thermite composition for a process of plugging and abandoning a petroleum well according to claim 3 or 4, wherein the tube-opening composition preferably comprises:
aluminium in an amount of 15-35 wt %,
a molybdenum oxide in an amount of 40-60 wt %, and
an iron oxide in an amount of 15-35 wt %.

18. The thermite composition for a process of plugging and abandoning a petroleum well according to claim 1, wherein a layering of the thermite composition inside a tubing provides the tube-sealing composition at the bottom, followed by the gas leakage-preventing composition.

19. The thermite composition for a process of plugging and abandoning a petroleum well according to claim 1, wherein a layering of the thermite composition further provides the tube-opening composition underneath the tube-sealing composition.

20. The thermite composition for a process of plugging and abandoning a petroleum well according to claim 17 or 18, wherein the layering of each thermite composition layer depends on a tubing diameter.

21. The thermite composition for a process of plugging and abandoning a petroleum well according to claim 17 or 18, wherein each thermite composition layer has a thickness ranging from 1-60 m.

22. A process of plugging and abandoning a petroleum well using a thermite composition, comprising the steps of:
a) preparing the thermite composition, which comprises
1.1 a tube-sealing composition comprising:
aluminium in an amount of 10-40 wt %, and
a metal oxide in an amount of 60-90 wt %
1.2 a gas leakage-preventing composition comprising a metal with a melting point ranging from 100-300° C.,
each component being mixed separately before arranging in a tubing;
b) plugging a petroleum well to be plugged and abandoned with a mechanical bridge plug before introducing the thermite composition into it;
c) layering the thermite composition prepared in step a) in a closed, hollow tubing, wherein the layering of the thermite composition provides the tube-sealing composition at the bottom, followed by the gas leakage-preventing composition, before introducing to the petroleum well to be plugged and abandoned;
d) initiating an ignition to generate thermal energy, triggering a thermite reaction that causes metal melting for tube sealing and preventing gas leakage, wherein an explosion caused by said thermite reaction occurs on the lateral and lower sides.

23. The process of plugging and abandoning a petroleum well using a thermite composition according to claim 22, wherein the metal oxide in step a) of preparing the thermite composition is selected from any one of copper oxide, molybdenum oxide, silicon dioxide, cobalt oxide, chromium oxide, titanium dioxide, nickel oxide, ferric oxide, ferrous oxide, or a mixture thereof.

24. The process of plugging and abandoning a petroleum well using a thermite composition according to claim 22, wherein the metal in step a) of preparing the thermite composition has a melting point ranging from 100-300° C. and is selected from bismuth, tin, or an alloy thereof.

25. The process of plugging and abandoning a petroleum well using a thermite composition according to claim 22, wherein a weight ratio of the gas leakage-preventing composition to the tube-sealing composition in step a) of preparing the thermite composition is in a range of 1:5 to 1:1.

26. The process of plugging and abandoning a petroleum well using a thermite composition according to claim 22, wherein the tube-sealing composition in step a) of preparing the thermite composition further comprises a metal powder in an amount of 1-35 wt % of the tube-sealing composition.

27. The process of plugging and abandoning a petroleum well using a thermite composition according to claim 26, wherein the metal powder is selected from any one of iron powder, chromium powder, nickel powder, molybdenum powder, or a mixture thereof.

28. The process of plugging and abandoning a petroleum well using a thermite composition according to claim 22, wherein the tube-sealing composition in step a) of preparing the thermite composition further comprises an auxiliary agent for separating metal slag in an amount of 1-35 wt % of the tube-sealing composition.

29. The process of plugging and abandoning a petroleum well using a thermite composition according to claim 22, wherein the tube-sealing composition in step a) of preparing the thermite composition further comprises an auxiliary agent for separating metal slag in an amount of 5-15 wt % of the tube-sealing composition.

30. The process of plugging and abandoning a petroleum well using a thermite composition according to claim 28 or 29, wherein the auxiliary agent for separating metal slag is preferably an oxide compound of an element selected from any one of calcium, magnesium, silicon, phosphorus, or a mixture thereof.

31. The process of plugging and abandoning a petroleum well using a thermite composition according to claim 28 or 29, wherein the auxiliary agent for separating metal slag is preferably any one of an alloy of iron and calcium, calcium silicide compound, or a mixture thereof.

32. The process of plugging and abandoning a petroleum well using a thermite composition according to claim 22, wherein in step c) of layering the thermite composition, the layering of each thermite composition layer depends on a tubing diameter.

33. The process of plugging and abandoning a petroleum well using a thermite composition according to claim 22, wherein in step c) of layering the thermite composition, each thermite composition layer has a thickness ranging from 1-60 m.

34. The process of plugging and abandoning a petroleum well using a thermite composition according to claim 22, wherein step c) of layering the thermite composition further comprises tightly sealing a tubing or covering a tubing with a thermal insulation material.

35. The process of plugging and abandoning a petroleum well using a thermite composition according to claim 22, wherein step d) of initiating the ignition is performed by heating between 500-1,500° C. to trigger the thermite reaction.

36. The process of plugging and abandoning a petroleum well using a thermite composition according to claim 22 further comprising a step of opening a tubing prior to melting the metal for tube sealing and preventing gas leakage, the opening of a tubing being selected from any one of cutting a tubing open using a mechanical force, perforation, opening a tubing using a chemical composition, or a combination thereof.

37. The process of plugging and abandoning a petroleum well using a thermite composition according to claim 36, wherein the chemical composition, which acts as a tube-opening composition in the step of opening a tubing comprises:
aluminium in an amount of 10-40 wt %, and
a metal oxide in an amount of 60-90 wt %.

38. The process of plugging and abandoning a petroleum well using a thermite composition according to claim 37, wherein the metal oxide is preferably selected from any one of molybdenum oxide, nickel oxide, chromium oxide ferric oxide, ferrous oxide, calcium peroxide, calcium oxide, or a mixture thereof.

39. The process of plugging and abandoning a petroleum well using a thermite composition according to claim 37, wherein the tube-opening composition preferably comprises:
aluminium in an amount of 15-25 wt %,
a molybdenum oxide in an amount of 15-35 wt %, and
a nickel oxide in an amount of 45-65 wt %.

40. The process of plugging and abandoning a petroleum well using a thermite composition according to claim 37, wherein the tube-opening composition preferably comprises:
aluminium in an amount of 10-30 wt %,
a nickel oxide in an amount of 55-75 wt %, and
an iron oxide in an amount of 5-25 wt %.

41. The process of plugging and abandoning a petroleum well using a thermite composition according to claim 37, wherein the tube-opening composition preferably comprises:
aluminium in an amount of 15-35 wt %,
a molybdenum oxide in an amount of 35-55 wt %, and
a chromium oxide in an amount of 20-40 wt %.

42. The process of plugging and abandoning a petroleum well using a thermite composition according to claim 37, wherein the tube-opening composition preferably comprises:
aluminium in an amount of 15-35 wt %,
a molybdenum oxide in an amount of 40-60 wt %, and
an iron oxide in an amount of 15-35 wt %.

43. The process of plugging and abandoning a petroleum well using a thermite composition according to claim 22, wherein step c) of layering the thermite composition further comprises a layering of the tube-opening composition underneath the tube-sealing composition.
